(19) United States
(12) Patent Application Publication
(10) Pub. No.: US 2006/0001939 A1
(43) Pub. Date: Jan. 5, 2006

(54) Dynamic bearing and beam deflecting apparatus employing the same

(75) Inventors: Sang-hoon Lee, Seongnam-si (KR); Hyun-surk Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/154,518

(22) Filed: Jun. 17, 2005

(30) Foreign Application Priority Data
Jul. 2, 2004 (KR) 10-2004-0051518

(51) Int. Cl. G02B 26/08

(52) U.S. Cl. 359/216; 359/198

(57) ABSTRACT

A dynamic bearing with an improved thrust bearing and a beam deflecting apparatus employing the same are disclosed. The dynamic bearing includes a bearing housing having a hollow cavity. A shaft is provided in the hollow cavity so that the shaft can rotate with respect to the bearing housing. First and second magnets are disposed at one end of the shaft and the hollow cavity, respectively. The first and second magnets are spaced a predetermined gap from each other and face each other. The first and second magnets generate a magnetic, repulsive force and support the shaft, without contact, in the axial and radial directions. The dynamic bearing may be used in a beam deflecting apparatus. In that case, a driving source is installed, in parts, on the bearing housing and the rotating shaft. The driving source drives the rotating shaft to rotate by electromagnetic force. A beam deflecting device is installed on the rotating shaft for deflecting an incident beam and performing a scanning operation.

### CROSS-REFERENCE TO RELATED APPLICATIONS

This application claims the benefit under 35 U.S.C. § 119(a) of Korean Patent Application No. 10-2004-0051518, filed on Jul. 2, 2004, the entire disclosure of which is hereby incorporated by reference.

### BACKGROUND OF THE INVENTION

1. Field of the Invention

The present invention relates to a fluid dynamic bearing for supporting a rotating body and a beam deflecting apparatus employing the same. More particularly, the present invention relates to a fluid dynamic bearing with an improved thrust bearing portion and a beam deflecting apparatus employing the same.

2. Description of the Related Art

In general, fluid dynamic bearings are employed in high-speed motors. A fluid dynamic bearing supports a rotating shaft by generating fluid (or air) dynamic pressure so that the rotating shaft is stable at high speeds. Fluid dynamic bearings are widely used in such applications as beam deflecting apparatuses in laser printers, optical storage devices, brushless DC motors, and similar applications.

As technology develops, the printing speed of laser printers tends to gradually become faster to meet user's requirements. Accordingly, in a beam deflecting apparatus, a polygon mirror (which is a kind of beam deflecting device) must be rotated at high speeds. The beam deflecting apparatus must also operate reliably for long periods of time.

Referring to FIG.1, a conventional fluid dynamic bearing supports a rotating shaft 1 so that the rotating shaft 1 can rotate. The bearing includes a housing 10 having a hollow cavity 13 partially filled with oil 1 1, a sleeve 15 inserted into the hollow cavity 13, and a thrust plate 17 supporting the rotating shaft 1 in an axial direction.

Grooves (not shown) having a herringbone shape are formed on the inner surface of the sleeve 15, that is, the surface facing the circumferential surface of the rotating shaft 1. The grooves generate dynamic pressure during rotational movement. In addition, the oil 11 forms a lubrication film between the sleeve 15 and the rotating shaft 1. The lower end of the rotating shaft 1 has a round shape to minimize the contact area between the rotating shaft 1 and the thrust plate 17. Therefore, when the rotating shaft 1 rotates at high speed, the sleeve 15 supports the rotating shaft 1 in radial directions, and the thrust plate 17 supports the rotating shaft 1 in an axial direction.

The physical contact between the thrust plate 17 and the lower end of the rotating shaft 1 causes problems in that it shortens the service life of the dynamic bearing, and generates undesirable, abrasive substances due to abrasion between the rotating shaft 1 and the thrust plate 17. In addition, when the conventional dynamic bearing described above is employed in a beam deflecting apparatus, the friction between the thrust plate 17 and the rotating shaft 1 limits the ability to increase the rotational speed of the polygon mirror.

Accordingly, there is a need for an improved dynamic bearing.

### SUMMARY OF THE INVENTION

An aspect of the present invention is to solve at least the above problems and/or disadvantages and to provide at least the advantages described below. Accordingly, an object of the present invention is to provide a dynamic bearing with an improved thrust bearing that supports a rotating shaft in an axial direction without contact, and, in addition, prevents the rotating shaft from unstable shaking in radial directions, and a beam deflecting apparatus employing the same.

According to an aspect of the present invention, a dynamic bearing includes a bearing housing having a hollow cavity. A shaft is provided in the hollow cavity and is installed so that it can rotate with respect to the bearing housing. A first magnet is disposed at one end of the shaft, and a second magnet is disposed in the hollow cavity. The magnets are spaced a predetermined gap from each other and face each other. The magnets support the shaft in both axial and radial directions without contact due to magnetic, repulsive forces between the first and second magnets.

According to another aspect of the present invention, a beam deflecting apparatus includes a bearing housing having a hollow cavity. A shaft is provided in the hollow cavity and is installed so that it can rotate with respect to the bearing housing. A first magnet is disposed at one end of the shaft, and a second magnet is disposed in the hollow cavity. The magnets are spaced a predetermined gap from each other and face each other. The magnets support the shaft in both axial and radial directions without contact due to magnetic, repulsive forces between the first and second magnets. A driving source is installed, in parts, at the bearing housing and the rotating shaft, and rotates the rotating shaft by electromagnetic forces. A beam deflecting device is installed on the rotating shaft for deflecting an incident beam and performing a scanning operation.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a schematic, sectional view of a conventional dynamic bearing;

FIG. 2 is a schematic, sectional view of a dynamic bearing according to a first embodiment of the present invention;

FIG. 3 is an enlarged, schematic sectional view of the lower portion of the dynamic bearing illustrated in FIG. 2;

FIG. 4 is a schematic, sectional view of a variation of the dynamic bearing shown in FIG. 2;

FIG. 5 is a schematic view of the surface of the sleeve of the dynamic bearing shown in FIG. 2;

FIG. 6 is a schematic, sectional view of a dynamic bearing according to a second embodiment of the present invention;

FIG. 7 is an enlarged, schematic sectional view of the lower portion of the dynamic bearing illustrated in FIG. 4;

FIG. 8 is a schematic, sectional view of a dynamic bearing according to a third embodiment of the present invention;

FIG. 9 is a schematic, sectional view of a dynamic bearing according to a fourth embodiment of the present invention; and

FIG. 10 is a schematic, sectional view of a beam deflecting apparatus according to an embodiment of the present invention.

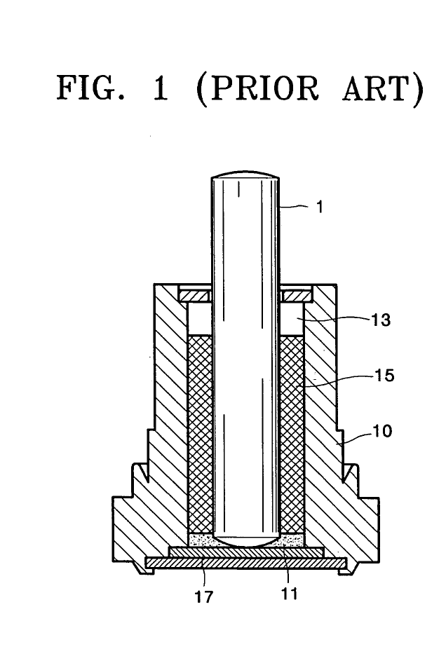

### Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

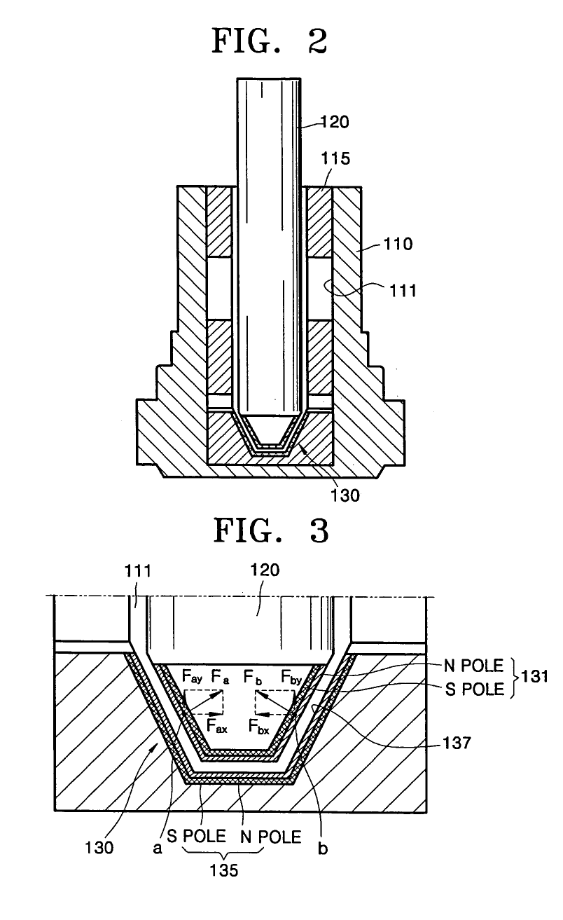

Referring to FIGS. 2 and 3, a fluid dynamic bearing according to a first embodiment of the present invention supports a rotating body (for example, a polygon mirror of an optical scanning apparatus, or a turntable of an optical recording and reproducing apparatus) by dynamic pressure of fluid or air to allow the rotating body to rotate. The dynamic bearing includes a bearing housing 110, a shaft 120, and a thrust bearing portion 130.

The bearing housing 110 has a hollow cavity 111. The shaft 120 is installed in the hollow cavity 111 so that the shaft 120 and the bearing housing 110 can rotate with respect to one another. Either the shaft 120 or the bearing housing 110 rotates together with the rotating body, while the other supports the rotating body in a static state so that the rotating body can rotate.

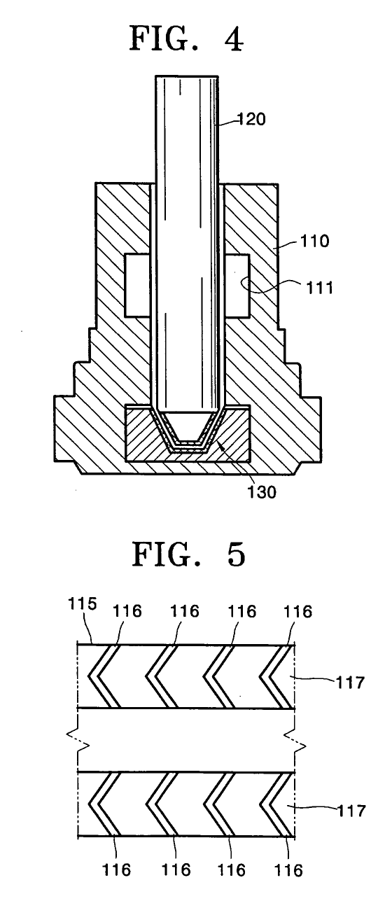

As illustrated in FIG. 4, the bearing housing 110 may have a structure provided within the hollow cavity 111 for directly supporting the shaft 120 so that the shaft 120 and bearing housing 110 can rotate with respect to one another. To directly support the shaft, grooves (not shown) having a predetermined shape, for example, a herringbone shape, can be formed at the inner surface of the hollow cavity 111.

Alternatively, as illustrated in FIGS. 2-3, one or more sleeves 115 for supporting the shaft 120 may be included in the hollow cavity 111. The sleeves 115 surround the shaft 120 in the hollow cavity 111. Grooves 116 (schematically illustrated in FIG. 5) having a predetermined shape are formed on the inner surfaces 117 (that is, the surfaces face the shaft 120) of the sleeves 115 so that dynamic pressure is generated during the rotating operation.

The thrust bearing portion 130 supports the shaft 120 so that the shaft 120 does not shake in the axial direction when the shaft 120 rotates with respect to the bearing housing 110. In addition, the thrust bearing portion 130 supports the end of the shaft 120 so that the end does not shake in the radial direction. As will be explained below, the thrust bearing portion 130 supports the shaft 120 without contact, thereby minimizing the abrasion of the shaft 120 due to friction and the generation of undesired, abrasive substances.

The thrust bearing portion 130 includes a first magnet 131 disposed at the end of the shaft 120. A second magnet 135 is disposed at a corresponding inner portion of the hollow cavity 111. The magnets face each other and are spaced a predetermined gap from each other. The first and second magnets 131 and 135 support the shaft 120 in axial and radial directions without contact due to magnetic repulsion between the magnets. To accomplish this, the poles and the shapes of the first and second magnets 131 and 135 are arranged in a specific disposition.

Referring to FIG. 3, the first and second magnets 131 and 135 are permanent magnets having respective S and N poles. Preferably, the first and second magnets 131 and 135 are disposed so that the N poles face each other, thereby generating magnetic, repulsive forces. As a result, the end of the shaft 120 does not contact the bearing housing 110. Alternatively, the first and second magnets 131 and 135 can be disposed so that the S poles face each other.

In addition, the first and second magnets 131 and 135 are shaped so that the magnetic, repulsive forces generated between the first and second magnets 131 and 135 have components in both the axial and radial directions of the shaft 120. To accomplish this, in the embodiment illustrated in FIGS. 2 and 3, the first magnet 131 has a truncated cone shape, and forms a taper at one end of the shaft 120. The second magnet 135 has a shape corresponding to that of the first magnet 131, and has a recessed portion 137. The first magnet 131 fits into the recessed portion 137 while being spaced a predetermined gap from the recess portion 137.

When the first and second magnets 131 and 135 are configured in this manner, the interaction between the first magnet 131 and the second magnet 135 supports the end portion of the shaft 120 in the axial and radial directions of the shaft 120. That is, the magnetic, repulsive forces at two arbitrary points a and b on the first magnet 131 can be expressed by Fa and Fb, respectively. The repulsive forces Fa and Fb are vector quantities, and are comprised of the sums of the respective vectors Fax and Fay, and vectors Fbx and Fby. The forces Fax and Fbx acting in the x-direction support the shaft 120 in the radial direction of the shaft 120, and the forces Fay and Fby acting in the y-direction support the shaft 120 in the axial direction of the shaft 120. Therefore, the thrust bearing portion 130 supports the end portion of the shaft 120 in the hollow cavity 111 in both the axial and radial directions without contact. Thus, the thrust bearing portion 130 stably supports the shaft 120 while preventing the formation of undesirable, abrasive substances by frictional contact between the thrust bearing portion 130 and the end of the shaft 120.

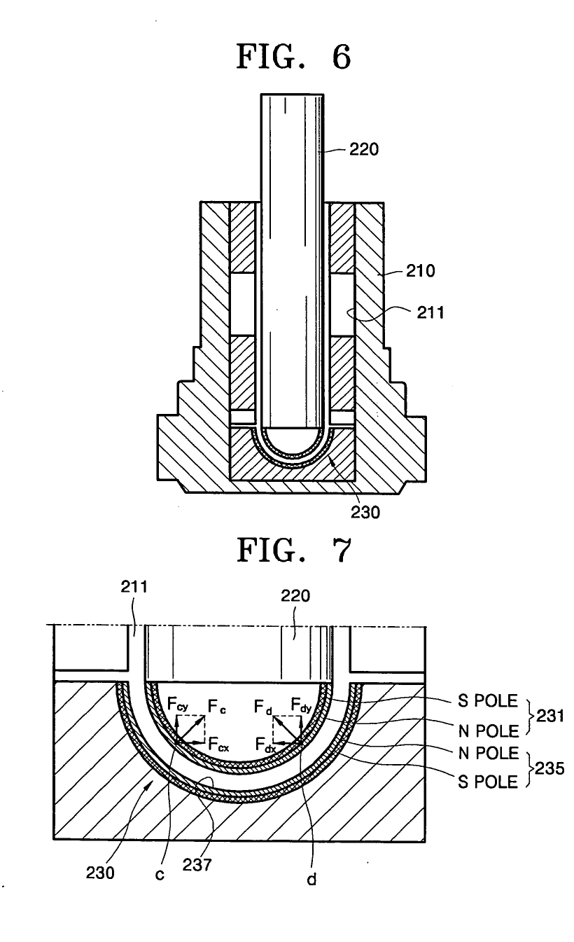

Referring to FIGS. 6 and 7, a dynamic bearing according to a second embodiment of the present invention includes a bearing housing 210 having a hollow cavity 211, a shaft 220 and a thrust bearing portion 230. The structure of the bearing housing 210 and the shaft 220 are substantially the same as those of the dynamic bearing of the first embodiment of the invention, so a detailed description is omitted for clarity and conciseness.

The thrust bearing portion 230 includes a first magnet 231 disposed at the end of the shaft 220. A second magnet 235 is disposed at a corresponding inner portion of the hollow cavity 211. The magnets face each other and are spaced a predetermined gap from each other. The first and second magnets 231 and 235 support the shaft 220 in axial and radial directions without contact due to magnetic repulsion between the magnets. The structure and disposition of the first and second magnets 231 and 235 in this second embodiment are substantially the same as the first and second magnets 131 and 135 in the first embodiment, except for their shapes.

Referring to FIG. 7, the first magnet 231 is hemispherically shaped, and projects from one end of the shaft 220. The second magnet 235 has a shape corresponding to that of the first magnet 231, that is, a hemispherically shaped recessed portion 233. The end of the first magnet 231 fits into the recessed portion 233 while being spaced a predetermined gap from the recessed portion 233.

When the first magnet 231 and the second magnet 235 are configured as described above, the interaction between the first magnet 231 and the second magnet 235 support the end of the shaft 220 in the axial and radial directions of the shaft 220. That is, the magnetic, repulsive forces at two arbitrary points c and d on the first magnet 231 can be expressed by Fc and Fd, respectively. The repulsive forces Fc and Fd are vector quantities, and are comprised of the sums of respective vectors Fcx and Fcy, and vectors Fdx and Fdy. The forces Fcx and Fdx acting in the x-direction support the shaft 220 in the radial direction of the shaft 220, and the forces Fcy and Fdy acting in the y-direction support the shaft 220 in the axial direction of the shaft 220.

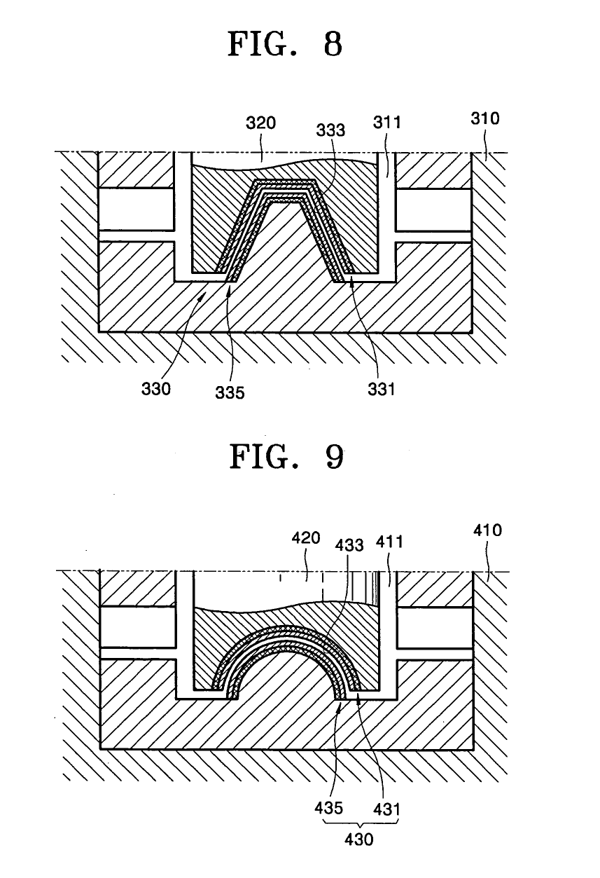

Referring to FIG. 8, a dynamic bearing according to a third embodiment of the present invention includes a bearing housing 310, a shaft 320 and a thrust bearing portion 330. The third embodiment is similar to the first embodiment, except for the shape of the magnets 331 and 335. Therefore, for clarity and conciseness, the modified portions are described while the description of unmodified portions is omitted.

Referring to FIG. 8, the first magnet 331 is formed at one end of the shaft 320, and includes a tapered recess 333. That is, a recess is formed at the end of the shaft 320, and the first magnet 331 is installed on the inner surfaces of the recess. The second magnet 335 is provided in a hollow cavity 311 of the bearing housing 310, and projects from the bottom surface of the cavity. The second magnet 335 has a truncated cone shape corresponding to the shape of the recess 333. Therefore, the magnetic, repulsive forces between the first and second magnets 331 and 335 support the shaft 320 without contact so that the shaft 320 can rotate.

Referring to FIG. 9, a dynamic bearing according to a fourth embodiment of the present invention includes a bearing housing 410, a shaft 420, and a thrust bearing portion 430. The dynamic bearing of this embodiment is similar to the second embodiment except for the shape of the first and second magnets 431 and 435. Therefore, for clarity and conciseness, the modified portions are described while the description of unmodified portions is omitted.

Referring to FIG. 9, the first magnet 431 is formed at one end of the shaft 420, and includes a hemispherically shaped recess 433. That is, a hemispherically shaped recess is formed at one end of the shaft 420, and the first magnet 431 is installed on the inner surfaces of the recess. The second magnet 435 is provided in a hollow cavity 411 of the bearing housing 410, and projects from the bottom surface of the cavity. The second magnet is hemispherically shaped and corresponds to the recess 433. Therefore, the magnetic, repulsive forces between the first and second magnets 431 and 435 support the shaft 420 without contact so that the shaft 420 can rotate.

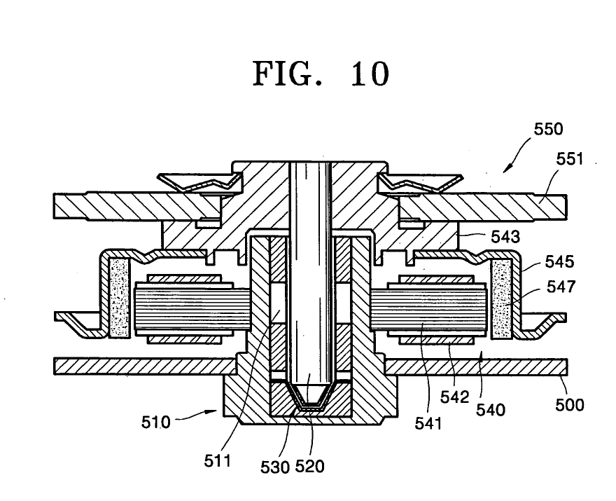

Referring to FIG. 10, a beam deflecting apparatus according to an embodiment of the present invention includes a bearing housing 510. The bearing housing 510 is fixed to a base 500 and has a hollow cavity 511. A rotating shaft 520 is provided in the hollow cavity 511 and rotates with respect to the bearing housing 510. A thrust bearing portion 530 supports the rotating shaft 520, a driving source 540, and a beam deflecting device 550.

The structures of the bearing housing 510, the rotating shaft 520, and the thrust bearing portion 530 are substantially the same as the respective structures of the bearing housings, the shafts, and the thrust bearing portions of the dynamic bearings according to the first through fourth embodiments of the present invention described with reference to FIGS. 2 through 9. Detailed descriptions are therefore omitted for clarity and conciseness.

The driving source 540 is installed, in parts, at the bearing housing 510 and the rotating shaft 520. The electromagnetic force of the driving source 540 rotates the rotating shaft 520. The driving source 540 includes a stator core 541, a rotor frame 543, a rotor housing 545, and a magnet 547. The stator core 541 is fixedly installed at the outer circumferential surface of the bearing housing 510, and includes a coil 542 wound around the stator core 541. The rotor frame 543 is installed at the outer circumferential surface of the rotating shaft 520, and the beam deflecting device 550 and the rotor housing 545 are installed at outer circumferential portions of the rotor frame 543. The rotor housing 545 is joined to the rotor frame 543, and encircles the circumference of the stator core 541. The magnet 547 is joined to and installed in the rotor housing 545, and is positioned to face the stator core 542.

The beam deflecting device 550 deflects an incident beam and performs a scanning operation while being rotated by the driving source 540. In this embodiment, the exemplary beam deflecting device 550 is a polygon mirror 551 having a plurality of reflecting mirrors on its side walls. Rather than a polygon mirror, the beam deflecting device 550 may include a hologon disk for deflecting an incident beam and performing a scanning operation according to a diffraction hologram pattern. Since the structures of the polygon mirror and the hologon disk are well-known, detailed descriptions are omitted for clarity and conciseness.

The dynamic bearing described above with respect to exemplary embodiments of present invention employs a thrust bearing structure that supports the end of the shaft without contact, in both the axial and radial directions, thereby preventing the shaft from shaking. Since the shaft is supported without contact, the thrust bearing structure prevents the generation of undesired abrasive substances due to contact between a static body and a rotating body.

In addition, a beam deflecting apparatus according to an exemplary embodiment of the present invention employs the dynamic bearing that supports one end of the rotating shaft in both axial and radial directions without contact. The beam deflecting device is therefore stably supported while rotating at high speed.

While the invention has been shown and described with reference to certain embodiments thereof, it will be understood by those skilled in the art that various changes in form and details may be made therein without departing from the spirit and scope of the invention. In particular, the dynamic bearing according to the present invention can be widely applied to not only the exemplary beam deflecting apparatus described above, but also all apparatuses that have a rotating body, for example, hard disk drives, optical disk drives, and the like. Accordingly, it should be understood that the scope of the present invention is defined by the appended claims rather than the foregoing description.

What is claimed is:

1. A dynamic bearing for supporting a rotating body comprising:
a bearing housing having a hollow cavity;
a shaft provided in the hollow cavity so that the shaft can rotate with respect to the bearing housing; and
first and second magnets which are disposed at an end of the shaft and the hollow cavity, respectively, and are spaced a predetermined gap from each other and face each other, the first and second magnets generating magnetic, repulsive forces for supporting the shaft in axial and radial directions without contact.

2. The dynamic bearing according to claim 1, wherein the first magnet projects from the end of the shaft as a taper, and the second magnet has a recessed portion corresponding to the shape of the first magnet.

3. The dynamic bearing according to claim 1, wherein the first magnet projects from the end of the shaft in a hemispherical shape, and the second magnet has a recessed portion corresponding to the shape of the first magnet.

4. The dynamic bearing according to claim 1, wherein the first magnet is formed as a tapered recess at one end of the shaft, and the second magnet projects from a bottom surface of the hollow cavity in a shape corresponding to the tapered recess.

5. The dynamic bearing according to claim 1, wherein the first magnet is formed as a hemispherical recess at one end of the shaft, and the second magnet projects from a bottom surface of the hollow cavity in a shape corresponding to the recess.

6. The dynamic bearing according to claim 1, wherein the bearing housing directly supports the shaft, and the bearing housing includes recessed grooves formed at the inner surface of the hollow cavity for generating dynamic pressure.

7. The dynamic bearing according to claim 1, wherein the dynamic bearing further comprises sleeves which are formed in the hollow cavity to surround the shaft, and the sleeves are provided with grooves formed at surfaces facing the shaft for generating dynamic pressure.

8. A beam deflecting apparatus comprising:
a bearing housing having a hollow cavity;
a rotating shaft provided in the hollow cavity so that the rotating shaft can rotate with respect to the bearing housing;
first and second magnets which are disposed at an end of the shaft and the hollow cavity, respectively, and are spaced a predetermined gap from each other and face each other, the first and second magnets generating magnetic, repulsive forces for supporting the shaft in axial and radial directions without contact;
a driving source installed, in parts, on the bearing housing and the rotating shaft, the driving source rotating the rotating shaft by electromagnetic force; and
a beam deflecting device installed on the rotating shaft for deflecting an incident beam and performing a scanning operation.

9. The beam deflecting apparatus according to claim 8, wherein the first magnet projects from the end of the shaft as a taper, and the second magnet has a recessed portion corresponding to the shape of the first magnet.

10. The beam deflecting apparatus according to claim 8, wherein the first magnet projects from the end of the shaft in a hemispherical shape, and the second magnet has a recessed portion corresponding to the shape of the first magnet.

11. The beam deflecting apparatus according to claim 8, wherein the first magnet is formed as a tapered recess at one end of the shaft, and the second magnet projects from a bottom surface of the hollow cavity in a shape corresponding to the tapered recess.

12. The beam deflecting apparatus according to claim 8, wherein the first magnet is formed as a hemispherical recess at one end of the shaft, and the second magnet projects from a bottom surface of the hollow cavity in a shape corresponding to the recess.

13. The beam deflecting apparatus according to claim 8, wherein the bearing housing directly supports the shaft, and the bearing housing includes recessed grooves formed at the inner surface of the hollow cavity for generating dynamic pressure.

14. The beam deflecting apparatus according to claim 8, wherein the dynamic bearing further comprises sleeves which are formed in the hollow cavity to surround the shaft, and the sleeves are provided with grooves formed at surfaces facing the shaft for generating dynamic pressure.

15. The beam deflecting apparatus according to claim 8, wherein the beam deflecting device is a polygon mirror with a plurality of mirrors provided on its side walls, the beam deflecting device being driven to rotate by the driving source and reflecting an incident beam and performing a scanning operation.

16. A beam deflecting apparatus comprising:
a bearing housing with a cavity;
a rotating shaft rotatably disposed in the cavity, the rotating shaft having a first end and a second end;
a first magnet disposed at the first end of the rotating shaft;
a second magnet disposed in the bearing housing; the first and second magnets generating magnetic, repulsive forces for supporting the shaft without contact;
a motor for rotating the shaft; and
a beam deflecting device installed on the second end of rotating shaft.

17. A beam deflecting apparatus according to claim 16, wherein the beam deflecting device is a polygon mirror with a plurality of mirrors provided on its side walls.
